(19) United States
(12) Patent Application Publication
(10) Pub. No.: US 2026/0196423 A1
(43) Pub. Date: Jul. 9, 2026

(54) MECHANICAL KNOB SWITCH, KITCHEN APPLIANCE, CONTROL METHOD AND RELEVANT DEVICES

(71) Applicant: GUANGDONG ARCAIR APPLIANCE CO., LTD., FOSHAN (CN)

(72) Inventors: Zuotian KANG, FOSHAN (CN); Haijiang TANG, FOSHAN (CN)

(73) Assignee: GUANGDONG ARCAIR APPLIANCE CO., LTD., FOSHAN (CN)

(21) Appl. No.: 19/058,596

(22) Filed: Feb. 20, 2025

(30) Foreign Application Priority Data
Jan. 8, 2025 (CN) 202510031917.6

(51) Int. Cl. H01H 19/14; F24C 15/00; H01H 19/24

(52) U.S. Cl. CPC H01H 19/14; H01H 19/24; F24C 15/00

(57) ABSTRACT

The present disclosure provides a mechanical knob switch, a kitchen appliance product, a control method and a relevant device and belongs to the technical field of switch designing of kitchen appliance products. The mechanical knob switch includes a mechanical part and an electronic part. The electronic part includes a control panel and electronic switches arranged circularly are disposed on the control panel; the mechanical part is disposed on a surface of the control panel and includes a rotatable knob and a linkage rod fixedly connected with the knob and rotatable along with the knob; an end of the linkage rod is provided with a contact which is in contact with the control panel and triggers all electronic switches. The mechanical knob switch of the present disclosure solves the problem of inconvenience brought to some people using electronic switches for low safety of existing mechanical knobs and achieves the effect of improving the safety while meeting the user requirements by retaining the mechanical knobs.

### TECHNICAL FIELD

The present disclosure relates to the technical field of switch designing of kitchen appliance products and in particular to a mechanical knob switch, a kitchen appliance product, a control method and a relevant device.

### BACKGROUND

The traditional kitchen appliance products, for example, gas stoves, usually use a mechanical knob to control flame intensity. But behind the knob is actually connected with an air valve or electric switch. Considering the safety and control accuracy, electronic switches are gradually used in the existing kitchen appliance products to replace the traditional mechanical knobs for relevant control. Although these electronic switches realize more accurate and smarter control than the knobs, some users, such as the elderly, find it difficult to get accustomed to such electronic switches, and even experience inconvenience in use.

Currently, no effective technical solution exists to address the aforementioned issues.

### SUMMARY

The object of the present disclosure is to provide a mechanical knob switch, a kitchen appliance product, a control method and a relevant device, which solve the problem of inconvenience brought to some people using electronic switches for low safety of mechanical knobs and achieve the effect of improving the safety while meeting the user requirements by retaining the mechanical knobs.

According to a first aspect, the present disclosure provides a mechanical knob switch, which includes a mechanical part and an electronic part. The electronic part includes a control panel. The control panel is provided with circularly-arranged electronic switches. The mechanical part is disposed on a surface of the control panel and includes a rotatable knob and a linkage rod fixedly connected with the knob and rotatable along with the knob. One end of the linkage rod is provided with a contact which is in contact with the control panel and triggers all electronic switches.

The mechanical knob switch provided by the present disclosure combines the mechanical knob with the electronic switch, satisfying the needs of users accustomed to using knobs while enhancing safety, control accuracy, and enabling intelligent control.

Furthermore, the mechanical part further includes a sealing shell and all knobs are mounted on the sealing shell which fully covers the control panel.

According to a second aspect, the present disclosure provides a kitchen appliance product which includes the mechanical knob switch mentioned above.

According to a third aspect, the present disclosure provides a control method based on the above mechanical knob switch, which includes the following steps:
at step S1, based on an ambient temperature and a material type of the contact, obtaining a current temperature expansion coefficient of the contact;
at step S2, based on the temperature expansion coefficient, obtaining a frictional force between the contact and the control panel;
at step S3, based on the frictional force, obtaining an angular compensation value;
at step S4, based on the angular compensation value and a current rotation angle of the knob, obtaining a corrected angle;
at step S5, controlling the electronic switch based on the corrected angle.

By compensating the hysteresis of the mechanical structure with the control parameter, the hysteresis problem can be solved and the effect of increasing the control accuracy can be achieved.

Furthermore, the step S2 includes the following specific step:

At step S21, the frictional force is calculated based on the following formula:

$$f = {α}_{T} μ {F}_{N} ;$$

where ƒ is a frictional force, α_{T} is a current temperature expansion coefficient of the contact, μ is a frictional coefficient between the contact and the control panel, and F_{N} is a pressure between the contact and the control panel.

Furthermore, the step S3 includes the following specific step:
At step S31, the angular compensation value is calculated based on the following formula:

$$Δ θ = β f {θ}^{′} ;$$

when Δθ>Δθₘₐₓ, Δθ=Δθₘₐₓ;
where Δθ is an angular compensation value, β is a preset compensation factor, θ′ is a current rotation angle of the knob, and Δθₘₐₓ is a maximum angular compensation value.

Furthermore, the step S4 includes the following specific step.

At step S41, the corrected angle is calculated based on the following formula:

$$θ = Δθ + {θ}^{′} ;$$

where θ is a corrected angle.

According to a fourth aspect, the present disclosure provides a control apparatus, which includes:
a first obtaining module, configured to obtain a current temperature expansion coefficient of the contact based on an ambient temperature and a material type of the contact;
a second obtaining module, configured to obtain a frictional force between the contact and the control panel based on the temperature expansion coefficient;
a third obtaining module, configured to obtain an angular compensation value based on the frictional force;
a fourth obtaining module, configured to obtain a corrected angle based on the angular compensation value and a current rotation angle of the knob;
a control module, configured to control the electronic switch based on the corrected angle.

The control apparatus provided by the present disclosure can solve the hysteresis problem of the mechanical structure so as to enable the contact to accurately touch the corresponding electronic switch, thereby improving the entire control accuracy.

According to a fifth aspect, the present disclosure provides an electronic device which includes a processor and a memory. The memory stores computer readable instructions. The computer readable instructions are executed by the processor to perform the steps in the control method provided by the above third aspect.

According to a sixth aspect, the present disclosure provides a computer readable storage medium, storing computer programs. The computer programs are executed by a processor to perform the steps in the control method provided by the above third aspect.

As can be seen from the above, the mechanical knob switch provided by the present disclosure retains the traditional mechanical knob while incorporating electronic switches, simulating a finger-touch process through the knob. This not only meets the needs of users accustomed to using knobs but also achieves higher precision and more intelligent control to some extent. Furthermore, direct connection of the mechanical knob with an air valve or electric switch can be avoided, thereby effectively improving the safety.

Other features and advantages of the present disclosure will be subsequently described in the specification and will partially become obvious form the specification or be known by practice of the embodiments of the present disclosure. The objects and other advantages of the present disclosure can be implemented or obtained by the structure specially indicated in the written specification and drawings.

### BRIEF DESCRIPTION OF THE DRAWINGS

FIG. 1 is a partial exploded view illustrating a kitchen appliance product according to an embodiment of the present disclosure.

FIG. 2 is an exploded view illustrating a mechanical knob according to an embodiment of the present disclosure.

FIG. 3 is a schematic diagram illustrating a partial structure of the position a in FIG. 2.

FIG. 4 is a flowchart illustrating a control method according to an embodiment of the present disclosure.

FIG. 5 is a structural schematic diagram illustrating a control apparatus according to an embodiment of the present disclosure.

FIG. 6 is a structural schematic diagram illustrating an electronic device according to an embodiment of the present disclosure.

Numerals of the drawings are described below:
100. control panel, 110. electronic switch, 210. knob, 220. linkage rod, 230. contact, 240. sealing shell, 300. first obtaining module, 400. second obtaining module, 500. third obtaining module, 600. fourth obtaining module, 700. control module, 13. electronic device, 1301. processor, 1302. memory, 1303. communication bus.

### DETAILED DESCRIPTION OF THE EMBODIMENTS

The embodiments of the present disclosure will be described below in details with the examples thereof shown in the accompanying drawings, and the same or similar reference numerals represent same or similar elements or elements having same or similar function throughout the specification. The embodiments described below by referring to the accompanying drawings are merely illustrative and used only to explain the present disclosure rather than limit the present disclosure.

In the description of the present disclosure, it should be understood that the orientations or positional relationships indicated by terms such as “center”, “longitudinal”, “transverse”, “length”, “width”, “thickness”, “upper”, “lower”, “front”, “rear”, “left”, “right”, “vertical”, “horizontal”, “top”, “bottom”, “inside”, “outside”, “clockwise” and “counterclockwise” are based on the orientations or positional relationships shown in the drawings and are used only for convenience and simplification of descriptions of the present disclosure, rather than for indicating or implying that the indicated apparatus or element shall have a specific orientation and be configured or operated in a specific orientation. Thus, the terms shall not be understood as limiting of the present disclosure.

In the descriptions of the present disclosure, it should be noted that, unless otherwise clearly stated or defined, the terms “mount”, “connect”, “couple” and the like in the embodiments shall be understood in a broad sense, for example, may be fixed connection, or detachable connection, or formed into one piece; or may be mechanical connection, or electrical connection or mutual communication; or direct connection or indirect connection through an intermediate medium, or may be internal communication between two elements or mutual interaction of two elements. Those skilled in the art may understand the specific meanings of the above terms in the present disclosure according to actual situations.

In the present disclosure, unless otherwise clearly stated or defined, the first feature being “on” or “below” the second feature refers to that the first feature and the second feature are in direct contact, or the first feature and the second feature are not in direct contact but in indirect contact through an additional feature between them. Furthermore, the first feature being “above” or “on” the second feature refers to that the first feature is exactly over or obliquely above the second feature, or only refers to that the first feature has a higher horizontal height than the second feature. The first feature being “under” or “below” the second feature refers to that the first feature is exactly under or obliquely below the second feature, or only refers to that the first feature has a smaller horizontal height than the second feature.

Many different embodiments or examples provided hereunder are used to implement different structures of the present disclosure. For simplification of the disclosure of the present disclosure, the components and settings of specific examples are described below. Of course, they are merely examples and not intended to limit the present disclosure. Furthermore, in different examples of the present disclosure, the reference numerals and/or reference letters can be repeated for the purpose of simplification and clarity and they themselves do not indicate any relationship between the embodiments and/or settings discussed. In addition, the present disclosure provides examples of various specific processes and materials, but the persons of ordinary skills in the arts can be aware of application of other processes and/or use of other materials.

The technical solutions of the embodiments of the present disclosure will be fully and clearly described below in combination with the accompanying drawings in the embodiments of the present disclosure. Apparently, the embodiments described herein are merely some embodiments of the present disclosure rather than all embodiments. Those components of the embodiments of the present disclosure shown in the accompanying drawings are usually arranged and designed in different configurations. Therefore, detailed descriptions of the embodiments of the present disclosure provided in the accompanying drawings below are not intended to limit the scope of protection claimed by the present disclosure but only represent some selected embodiments of the present disclosure. All other embodiments obtained by those skilled in the arts based on these embodiments without carrying out creative work shall all fall within the scope of protection of the present disclosure.

It should be noted that like numerals and letters represent like items in the following drawings and thus, once one item is defined in one drawing, it is not necessary to further discuss this item in subsequent drawings. The terms “first” and “second” are used only for descriptions and shall not be understood as indicating or implying relative importance or implying a number of the indicated technical features. Thus, features limited by “first” and “second” may explicitly or implicitly include one or more features. In the descriptions of the present disclosure, “multiple” refers to two or more unless otherwise stated clearly. Furthermore, in the descriptions of the present disclosure, the terms “first” and “second” are used only to distinguish descriptions and shall not be understood as indicating or implying any relative importance.

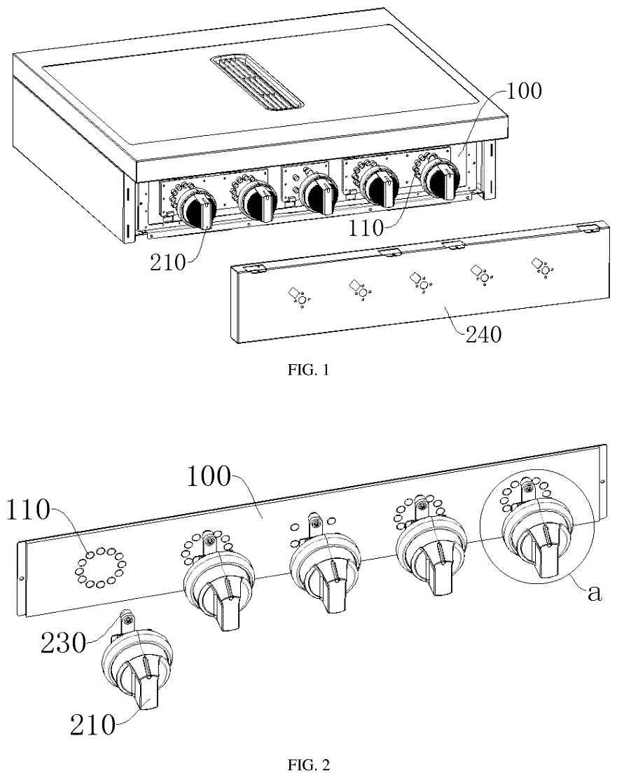

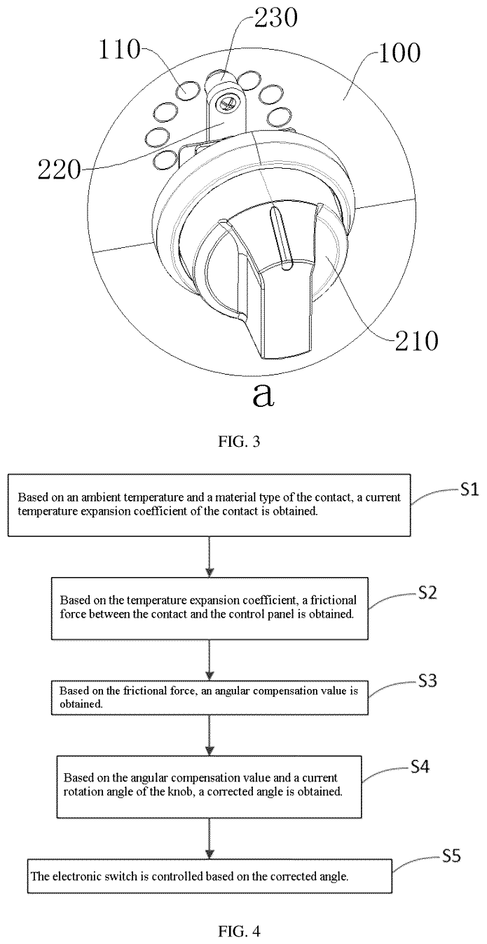

With reference to FIGS. 1, 2 and 3, the present disclosure provides a mechanical knob switch, which includes a mechanical part and an electronic part. The electronic part includes a control panel 100 and electronic switches 110 arranged circularly are disposed on the control panel 100; the mechanical part is disposed on a surface of the control panel 100 and includes a rotatable knob 210 and a linkage rod 220 fixedly connected with the knob 210 and rotatable along with the knob 210. An end of the linkage rod 220 is provided with a contact 230 which is in contact with the control panel 100 and triggers all electronic switches 110.

In the embodiment, the mechanical knob 210 is combined with the electronic switch 110 such that the contact 230 on the knob 210 can touch the electronic switch 110 like a finger, so as to realize indirect control. In this way, the advantages of the existing control panel 110 in high-accuracy and smart control can be retained and the direct connection of the knob 210 with an air valve or electric switch can be avoided while retaining the traditional knob 210. Therefore, the use habit of the users can be satisfied and the effects such as safety and reliability, smart control and convenient use and the like can be achieved. Furthermore, compared with hand operation, the operation such as tap or slide or the like with the contact 230 in place of fingers is favourable for reducing the mis-trigger risk, making the control more accurate.

It should be noted that the electronic switch 110 may be a touch switch or light-sensing switch. Specifically, the touch switch can be triggered by contacting with the contact 230 and the light-sensing switch can be triggered by light affected by the contact 230.

In some embodiments, with reference to FIG. 1, the mechanical part further includes a sealing shell 240 and all knobs 210 are mounted on the sealing shell 240 which fully covers the control panel 100. The sealing shell 240 seals the control panel, which improves the protection effects of the control panel 100 in water resistance, moisture resistance and oil fume resistance and the like.

In some embodiments, the knob 210 may also be provided with an LED display lamp (not shown) to help a user to determine a mode or level based on light at the time of operating the knob 210.

With reference to FIG. 1, the present disclosure provides a kitchen appliance product, which includes the mechanical knob switch in the above embodiment.

Limited by the processing accuracy and assembling accuracy, it is inevitable that a gap is present among the knob 210, the linkage rod 220 and the contact 230. The gap enables the above three to move relative to each other and affect the control accuracy of the knob 210. In the practical applications, since the contact 230 is always in contact with the control panel 100 and the contact 230 may suffer thermal expansion and cold contraction under the influence of ambient temperature, a frictional force between the contact 230 and the control panel 100 may change. Due to the frictional force and the gap, a hysteresis phenomenon may occur to the mechanical structure. For example, the knob 210 has already rotated to an angle, but the contact 230 is still in its original position. This hysteresis phenomenon disables the knob 210 to accurately control the movement of the contact 230 and hence disables the contact to accurately touch the corresponding electronic switch 110, thereby reducing the entire control accuracy.

With reference to FIG. 4, the present disclosure provides a control method based on the mechanical knob switch in the above embodiment, which includes the following steps.

At step S1, based on an ambient temperature and a material type of the contact, a current temperature expansion coefficient of the contact is obtained.

At step S2, based on the temperature expansion coefficient, a frictional force between the contact and the control panel is obtained.

At step S3, based on the frictional force, an angular compensation value is obtained.

At step S4, based on the angular compensation value and a current rotation angle of the knob, a corrected angle is obtained.

At step S5, the electronic switch is controlled based on the corrected angle.

Specifically, it is supposed that an included angle between the positions where two adjacent electronic switches 110 can be triggered is 30°. If no hysteresis phenomenon occurs to the mechanical structure, the knob 210 can directly trigger a next electronic switch 110 by rotating 30° from a previous electronic switch 110.

However, in practical applications, due to influence of the hysteresis phenomenon, before compensation, when the knob 210 rotates 30°, the contact 230 can rotate only 25°. At this time, the contact 230 does not trigger a next electronic switch 110. By the compensation in this embodiment, the contact 230 is compensated with 5° from the level of parameter (the contact 230 actually does not move), so as to simulate a signal of a rotation of 30° of the contact 230 and further trigger the next electronic switch 110. In the embodiment, by compensating the hysteresis of the mechanical structure with the control parameter, the hysteresis problem can be solved and the effect of increasing the control accuracy can be achieved.

In some embodiments, the step S2 includes the following specific step.

At step S21, the frictional force is calculated based on the following formula:

$$f = {α}_{T} μ {F}_{N} ;$$

where ƒ is a frictional force, α_{T} is a current temperature expansion coefficient of the contact, μ is a frictional coefficient between the contact and the control panel, and F_{N} is a pressure between the contact and the control panel.

It should be noted that the current temperature expansion coefficient of the contact 230 and the frictional force between the contact 230 and the control panel 100 is affected by the material type of the contact 230 and the control panel 100. Therefore, the frictional coefficient between the contact 230 and the control panel 100 can be determined based on the material type and the temperature expansion coefficient can be determined based on the current ambient temperature. The pressure between the contact 230 and the control panel 100 can be measured by a pressure sensor on the control panel 100.

In some embodiments, the step S3 includes the following specific step.

At step S31, the angular compensation value is calculated based on the following formula:

$$Δ θ = β f {θ}^{′} ;$$

when Δθ>Δθₘₐₓ, Δθ=Δₘₐₓ;
where Δθ is an angular compensation value, β is a preset compensation factor, θ′ is a current rotation angle of the knob, and Δθₘₐₓ is a maximum angular compensation value.

In some embodiments, the step S4 includes the following specific step.

At step S41, the corrected angle is calculated based on the following formula:

$$θ = Δ θ + {θ}^{′} ;$$

where θ is a corrected angle.

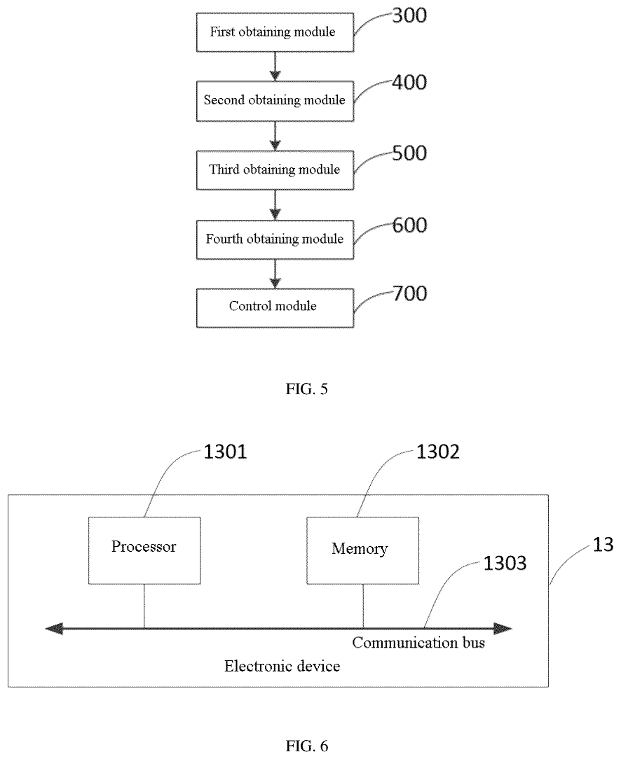

With reference to FIG. 5, it shows a control apparatus according to some embodiments of the present disclosure. The control apparatus is integrated into a backend control device in the form of computer program. The control apparatus includes:
a first obtaining module 300, configured to obtain a current temperature expansion coefficient of the contact based on an ambient temperature and a material type of the contact;
a second obtaining module 400, configured to obtain a frictional force between the contact and the control panel based on the temperature expansion coefficient;
a third obtaining module 500, configured to obtain an angular compensation value based on the frictional force;
a fourth obtaining module 600, configured to obtain a corrected angle based on the angular compensation value and a current rotation angle of the knob;
a control module 700, configured to control the electronic switch based on the corrected angle.

In some embodiments, when the second obtaining module 400 is configured to obtain the frictional force between the contact and the control panel based on the temperature expansion coefficient, the second obtaining module 400 performs the following operation:

At step S21, the frictional force is calculated based on the following formula:

$$f = {α}_{T} μ {F}_{N} ;$$

where ƒ is a frictional force, α_{T} is a current temperature expansion coefficient of the contact, μ is a frictional coefficient between the contact and the control panel, and F_{N} is a pressure between the contact and the control panel.

In some embodiments, when the third obtaining module 500 is configured to obtain the angular compensation value based on the frictional force, the third obtaining module 500 performs the following operation:

At step S31, the angular compensation value is calculated based on the following formula:

$$Δ θ = β f {θ}^{′} ;$$

when Δθ>Δθₘₐₓ, Δθ=Δθₘₐₓ;
where Δθ is an angular compensation value, β is a preset compensation factor, θ′ is a current rotation angle of the knob, and Δθₘₐₓ is a maximum angular compensation value.

In some embodiments, when the fourth obtaining module 600 is configured to obtain the corrected angle based on the angular compensation value and the current rotation angle of the knob, the fourth obtaining module 600 performs the following operation:

At step S41, the corrected angle is calculated based on the following formula:

$$θ = Δ θ + {θ}^{′} ;$$

where θ is a corrected angle.

With reference to FIG. 6, it shows a structural schematic diagram illustrating an electronic device according an embodiment of the present disclosure. The present disclosure provides an electronic device 13, which includes a processor 1301 and a memory 1302. A processor 1301 and a memory 1302 are mutually communicated via a communication bus 1303 or another form of connection mechanism (not shown). The memory 1302 stores computer-readable instructions executable by the processor 1301. When the electronic device runs, the processor 1301 executes the computer readable instructions to perform the control method in any optional implementation of the above embodiments so as to execute the following functions: based on an ambient temperature and a material type of the contact, obtaining a current temperature expansion coefficient of the contact; based on the temperature expansion coefficient, obtaining a frictional force between the contact and the control panel; based on the frictional force, obtaining an angular compensation value; based on the angular compensation value and a current rotation angle of the knob, obtaining a corrected angle; controlling the electronic switch based on the corrected angle.

An embodiment of the present disclosure provides a computer readable storage medium, storing computer programs. The computer programs are executed by a processor to perform the control method in an optional implementation of the above embodiments so as to execute the following functions: based on an ambient temperature and a material type of the contact, obtaining a current temperature expansion coefficient of the contact; based on the temperature expansion coefficient, obtaining a frictional force between the contact and the control panel; based on the frictional force, obtaining an angular compensation value; based on the angular compensation value and a current rotation angle of the knob, obtaining a corrected angle; controlling the electronic switch based on the corrected angle.

The computer readable storage medium may be implemented by any type of volatile or non-volatile storage devices or a combination thereof. The volatile or non-volatile storage devices include but not limited to a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic disk or a compact disk.

In the embodiments of the present disclosure, it should be understood that the disclosed apparatus and method can be implemented another way. The above-mentioned apparatus embodiments are merely illustrative. For example, the unit division is only one logical functional division and may be another division during actual implementation. For example, multiple units or components may be combined or integrated into another system or some features may be neglected or not executed. Furthermore, mutual coupling or direct coupling or communication displayed or discussed may be indirect coupling or communication between the apparatuses or units through some communication interfaces, which may be in electrical, mechanical or another form.

Furthermore, the units described as separate members may be or not be physically separated, and the members displayed as units may be or not be physical units, i.e., may be located in one place, or may be distributed to a plurality of network units. Part or all of the modules may be selected according to actual requirements to implement the objectives of the solutions in the embodiments.

Furthermore, various functional modules in various embodiments of the present disclosure may be integrated together to form one independent part, or may be present physically separately, or two or more modules thereof may be integrated to form one independent part.

It shall be noted that the relational terms such as “first” and “second” used herein are merely intended to distinguish one entity or operation from another entity or operation rather than to require or imply any such actual relation or order existing between these entities or operations.

The descriptions made by referring to the terms “one embodiment”, “some embodiment”, “illustrative embodiments” “example” “specific example” or “some examples” or the like are intended to mean that specific features, structures, material or characteristics described in combination with the embodiments or the examples are included in at least one embodiment or example of the present disclosure. In the specification, the illustrative expressions of the above terms do not necessarily refer to a same embodiment or example. Further, the described specific features, structures, materials, or characteristics may be combined in a proper way in one or more embodiments or examples.

The above are only the embodiments of the present disclosure and not intended to limit the scope of protection of the present disclosure. Those skilled in the arts can make various modifications and changes to the present disclosure. Any modifications, equivalent substitutions and improvements and the like made within the spirit and principle of the present disclosure shall fall within the scope of protection of the present disclosure.

1. A mechanical knob switch, comprising a mechanical part and an electronic part, wherein the electronic part comprises a control panel (100) and electronic switches (110) arranged circularly are disposed on the control panel (100); the mechanical part is disposed on a surface of the control panel (100) and comprises a rotatable knob (210) and a linkage rod (220) fixedly connected with the knob (210) and rotatable along with the knob (210); an end of the linkage rod (220) is provided with a contact (230) which is in contact with the control panel (100) and triggers all electronic switches (110).

2. The mechanical knob switch of claim 1, wherein the mechanical part further comprises a sealing shell (240), and all knobs (210) are mounted on the sealing shell (240) which fully covers the control panel (100).

3. A kitchen appliance product, comprising the mechanical knob switch according to claim 1.

4. A control method based on the mechanical knob switch according to claim 1, comprising the following steps:
at step S1, based on an ambient temperature and a material type of the contact, obtaining a current temperature expansion coefficient of the contact;
at step S2, based on the temperature expansion coefficient, obtaining a frictional force between the contact and the control panel;
at step S3, based on the frictional force, obtaining an angular compensation value;
at step S4, based on the angular compensation value and a current rotation angle of the knob, obtaining a corrected angle;
at step S5, controlling the electronic switch based on the corrected angle.

5. The control method of claim 4, wherein the step S2 comprises the following specific step:
at step S21, the frictional force is calculated based on the following formula:
$$f = {α}_{T} μ {F}_{N} ;$$
where ƒ is a frictional force, α_{T} is a current temperature expansion coefficient of the contact, μ is a frictional coefficient between the contact and the control panel, and F_{N} is a pressure between the contact and the control panel.

6. The control method of claim 5, wherein the step S3 comprises the following specific step:
at step S31, the angular compensation value is calculated based on the following formula:
$$Δ θ = β f {θ}^{′} ;$$
when Δθ>Δθₘₐₓ, Δθ=Δθₘₐₓ;
where Δθ is an angular compensation value, β is a preset compensation factor, θ′ is a current rotation angle of the knob, and Δθₘₐₓ is a maximum angular compensation value.

7. The control method of claim 6, wherein the step S4 comprises the following specific step:
at step S41, the corrected angle is calculated based on the following formula:
$$θ = Δ θ + {θ}^{′} ;$$
where θ is a corrected angle.

8. A control apparatus, comprising:
a first obtaining module, configured to obtain a current temperature expansion coefficient of the contact based on an ambient temperature and a material type of the contact;
a second obtaining module, configured to obtain a frictional force between the contact and the control panel based on the temperature expansion coefficient;
a third obtaining module, configured to obtain an angular compensation value based on the frictional force;
a fourth obtaining module, configured to obtain a corrected angle based on the angular compensation value and a current rotation angle of the knob;
a control module, configured to control the electronic switch based on the corrected angle.

9. An electronic device, comprising a processor and a memory, wherein the memory stores computer-readable instructions that, when executed by the processor, cause the processor to perform the steps of the control method according to claim 4.

10. A computer-readable storage medium storing computer programs that, when executed by a processor, cause the processor to perform the steps of the control method according to claim 4.
